(19) United States
(12) Patent Application Publication
(10) Pub. No.: US 2002/0163656 A1
(43) Pub. Date: Nov. 7, 2002

(54) Image recording apparatus

(76) Inventor: Yasushi Nakasone, Tokyo (JP)

Correspondence Address: RABIN & CHAMPAGNE, PC, 1101 14TH STREET, NW, SUITE 500, WASHINGTON, DC, 20005, US

(21) Appl. No.: 10/138,660

(22) Filed: May 6, 2002

(30) Foreign Application Priority Data
May 7, 2001 (JP) 2001-135788

(51) Int. Cl. B41J 1/00; G06F 15/00

(52) U.S. Cl. 358/1.4; 358/1.8

(57) ABSTRACT

An image recording apparatus has a plurality of print engines aligned along a transport path in which a recording medium is transported. Each of the plurality of print engines records a corresponding toner image on the recording medium. The apparatus includes a plurality of rows of LED arrays each of which includes a plurality of LED arrays and is assembled in a corresponding one of the print engines. Each of the plurality of rows extends in a direction substantially perpendicular to the transport path and illuminates a surface of a photoconductive drum in a corresponding print engine, and forms an electrostatic latent image on the photoconductive drum. The plurality of rows are staggered such that a following one of the rows of adjacent print engines is a predetermined distance ahead of a preceding one of the rows of the adjacent print engines.

### BACKGROUND OF THE INVENTION

1. Field of the Invention

The present invention relates to an image-recording apparatus and more particularly to an image-recording apparatus in which a plurality of images are recorded in register to recording paper.

2. Description of the Related Art

FIG. 12 is a top view of a pertinent portion of one such image-recording apparatus, illustrating the arrangement of image-forming sections.

Referring to FIG. 12, a color image-recording apparatus includes yellow magenta, cyan, and black image-forming sections 102, 103, 104, and 105 that are aligned in a direction shown by arrow A in which recording paper 113 is transported. Each image forming section has an LED head 16.

FIG. 13 is a perspective view of a pertinent portion of the LED head 16 except a self-focusing lens array.

All the image-forming sections are of the same configuration. A predetermined number of LED arrays 21 each of which includes a plurality of light-emitting diodes (LEDs) 22 aligned straight at predetermined intervals. The predetermined number of LED arrays are aligned straight on a circuit board 20 such that the LEDs of the LED arrays 21 form a straight line as a whole.

Drive ICs 23 are disposed beside the LED arrays 21 and drive the corresponding LED arrays. The LED head 16 (FIG. 13) incorporates a self-focusing lens array 16 that focuses the light emitted from the LED arrays 21. The LED heads 16 at the respective image-forming sections are disposed such that the LEDs of the LED heads 16 form parallel lines in the A direction and parallel lines transverse to the A direction.

As described later, each of the image-forming sections 102-105 incorporates a photoconductor that is illuminated by a corresponding LED head 16. The image-forming sections record corresponding color images in register in sequence to the recording paper 113 that is transported in the A direction.

As shown in FIG. 13, a plurality of LED arrays 21 are mounted on the circuit board 20 such that the LEDs in the LED arrays are aligned in a straight line as a whole. However, due to manufacturing variations, the distance between end most LEDs of adjacent LED arrays tends to be several microns longer than that between adjacent LEDs in the adjacent LED arrays, creating a detectable size of area not illuminated by the LED head.

Because the LED heads 16 of the respective image-forming sections 102-105 are of the same configuration, the aforementioned problem of the distance between the end most LEDs of adjacent LED arrays occurs at corresponding locations in the respective LED heads 16. In other words, areas not illuminated properly due to the improper spacing between adjacent LED arrays also appear in the A direction, causing detectable lines to appear in the printed image. This leads to poor print quality.

### SUMMARY OF THE INVENTION

An object of the invention is to provide an image-recording apparatus that is capable of recording a color image that is less sensitive to variations in print density resulting from mounting errors of LED arrays in LED heads of the respective image-forming sections.

An image recording apparatus includes a plurality of image-forming sections that record corresponding toner images on a recording medium in register. Each of the plurality image-forming sections has a corresponding one of a plurality of exposing units. Each of the plurality of exposing units has a corresponding one of rows of arrays of light-emitting elements. Each of the plurality of rows has a plurality of arrays of light-emitting elements aligned straight in a direction in which the light-emitting elements are aligned. Adjacent rows are staggered so that adjacent endmost light-emitting elements of adjacent arrays in a preceding one of the adjacent rows are a predetermined distance ahead of corresponding adjacent endmost light-emitting elements of the adjacent arrays in a following one of the adjacent rows.

The image-forming sections are of the same configuration. The image-forming sections are staggered so that adjacent endmost light-emitting elements of adjacent arrays in a preceding one of the adjacent rows are a predetermined distance ahead of corresponding adjacent endmost light-emitting elements of the adjacent arrays in a following one of the adjacent rows.

The image-forming sections are of the same configuration. The exposing units are mounted to the image-forming sections in a staggered fashion. In other words, adjacent end most light-emitting elements of adjacent arrays in a preceding one of the adjacent rows are a predetermined distance ahead of corresponding adjacent endmost light-emitting elements of the adjacent arrays in a following one of the adjacent rows.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limiting the present invention, and wherein:

FIG. 1 illustrates a general construction of an image-forming apparatus according to a first embodiment;

FIG. 2 illustrates a configuration of an LED head;

FIG. 3 is a top view of print engines arranged in the color image recording apparatus;

FIG. 4 illustrates the positional relationship among the LED heads in the color image-recording apparatus;

FIG. 5 illustrates the driver ICs and LED arrays chips arranged on the circuit board for one of the LED heads;

FIG. 6 illustrates the detailed circuit configuration in each drive IC and LED array, showing electrical connection;

FIG. 7 is a timing chart for driving drive ICs and LED arrays, showing only (N−1) th drive IC and LED array to (N−1) th drive IC and LED array by way of example;

FIG. 8 is a block diagram of a control circuit that controls respective mechanisms of the color image recording apparatus of FIG. 1;

FIG. 9 is a front view of a color image recording apparatus according to a second embodiment;

FIG. 10 is a top view of an image-forming unit, illustrating the positional relation of the respective print engines fixed to frames of the image-forming unit;

FIG. 11 illustrates the positional relationship of LED heads among a plurality of print engines according to the second embodiment;

FIG. 12 is a top view of a pertinent portion of a conventional image-recording apparatus, illustrating the arrangement of image forming sections; and

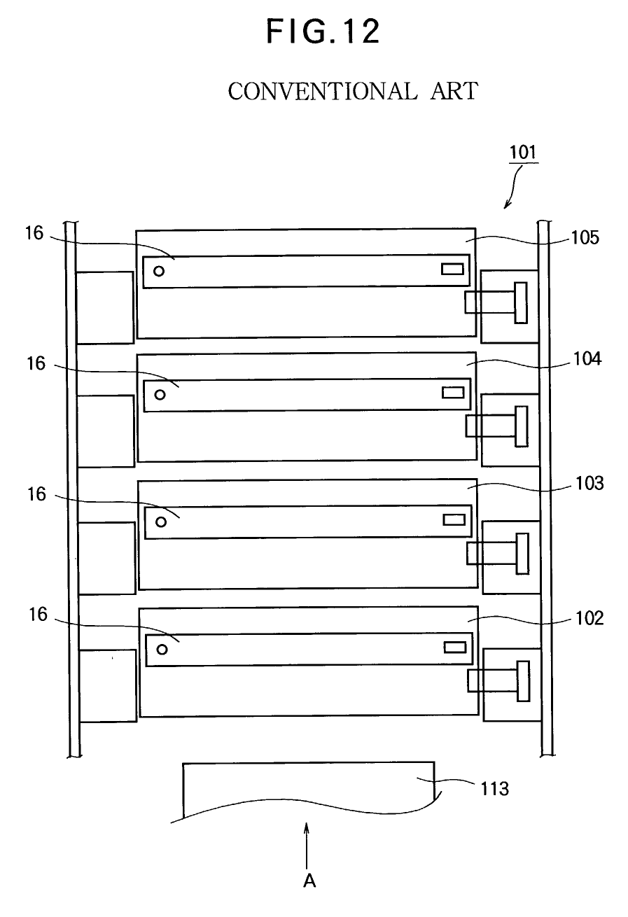

FIG. 13 is a perspective view of LED arrays and drive ICs of an LED head of the conventional image-recording apparatus of FIG. 8.

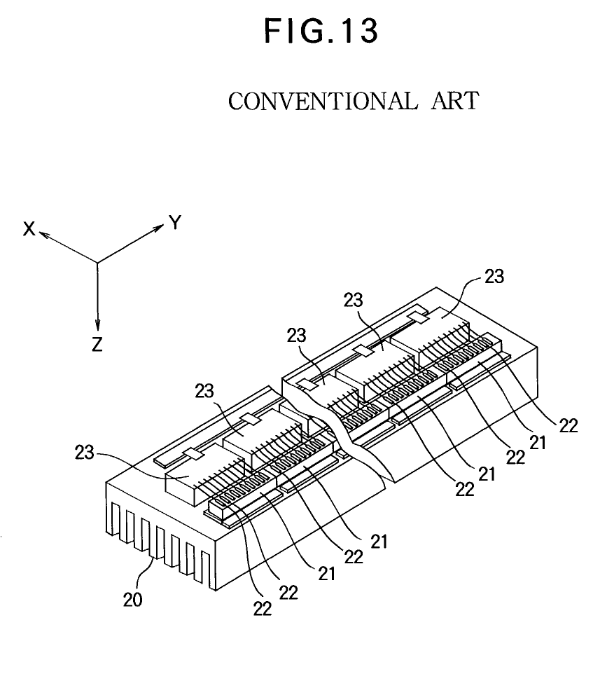

### DETAILED DESCRIPTION OF THE INVENTION

### FIRST EMBODIMENT

### Construction

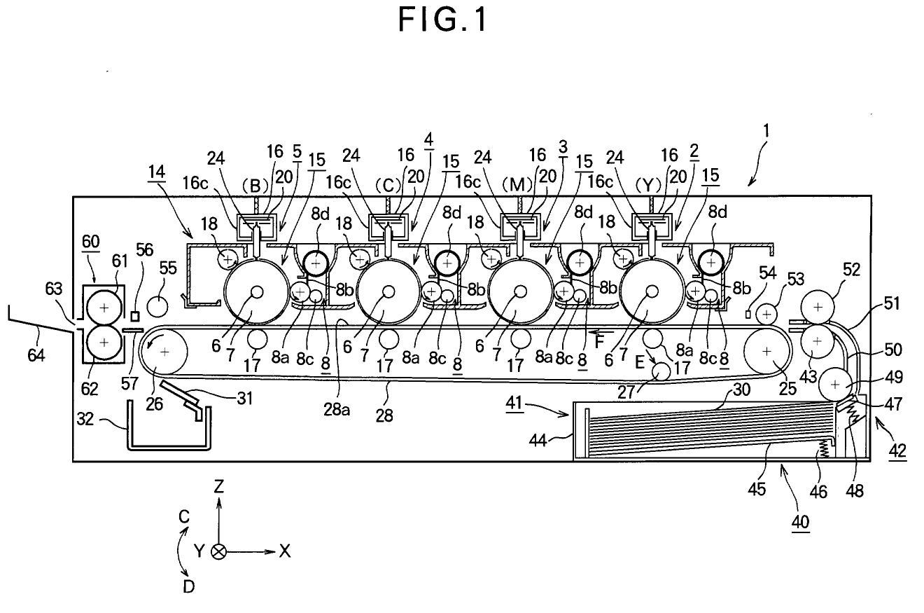

FIG. 1 illustrates a general construction of an image-forming apparatus according to a first embodiment of the present invention.

In FIG. 1, an X-axis indicates a direction in which four print engines are aligned, a Y-axis indicates directions in which the shafts of the photoconductive drums 7 extend, and a Z-axis indicates a direction perpendicular to the X-axis and the Y-axis.

Referring to FIG. 1, a color image-recording apparatus 1 has a color image-forming unit 14 that includes four print engines 2, 3, 4, and 5 in integral construction. The four print engines are aligned along a transport path in which recording paper 30 is transported. The print engines have photoconductive drums 7 that rotate about shafts 6 extending in directions perpendicular to the transport path.

The print engines 2-5 are LED-type electrophotographic printing mechanisms of the same configuration. Each of the print engines 2-5 includes an image-forming section 15, an LED head 16 that illuminates the photoconductive drum 7 in accordance with print data, and a transfer roller 17 that transfers a toner image from the photoconductive drum 7 onto the recording paper 30.

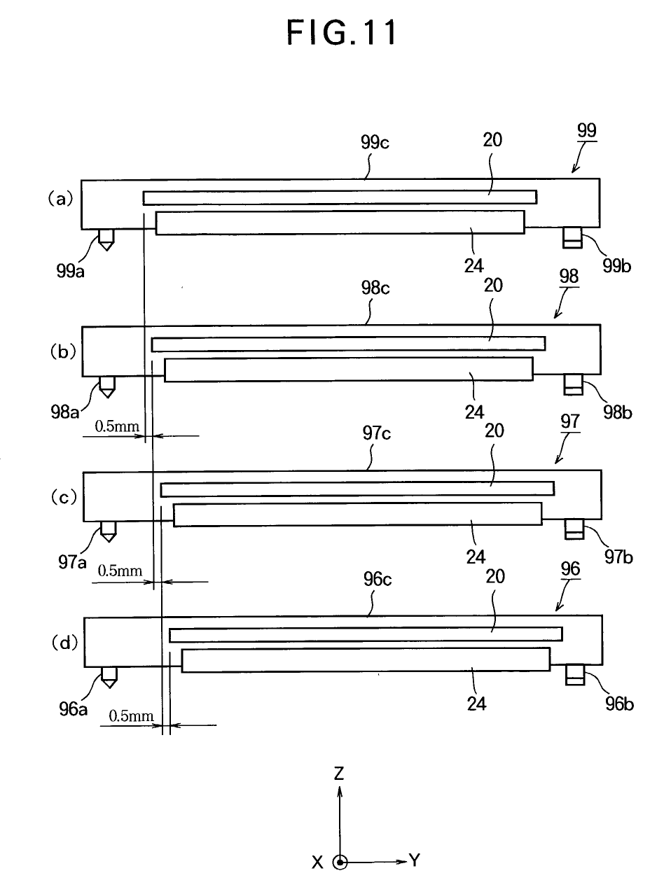

Referring back to FIG. 1, the LED head 16 has a circuit board 20 and a self-focusing lens array 24. The circuit board 20 is mounted to the inner upper portion of a chassis 16c. The circuit board 20 has a plurality of LED arrays 21 mounted thereon in the same manner as shown in FIG. 11, the LEDs in the LED arrays 21 being aligned at equal intervals on a straight line. The drive ICs 23 are disposed adjacent the LED arrays 21 and drive the corresponding LED arrays 21.

The circuit board 20 is attached to the chassis 16c so that the LED arrays 21 face downward. The self-focusing lens array 24 focuses the light emitted from the LED arrays 21 on the circumferential surface of the photoconductive drum 7.

The LED array 21 emits light in accordance with print data received through a later described interface section, and the self-focusing lens array 24 focuses the light to illuminate the circumferential surface of the photoconductive drum 7 to form an electrostatic latent image thereon.

The print engine 15 includes the photoconductive drum 7, a charging roller 18, and a developing section 8. The photoconductive drum 7 rotates about a rotational shaft 6 in a direction shown by arrow C. The charging roller 18 charges the circumferential surface of the photoconductive drum 7 uniformly. The developing section 8 includes a developing roller 8a, a developing blade 8b, a sponge roller 8c, and a toner tank 8d.

The toner tank 8d supplies a non-magnetic toner to the sponge roller 8c, and the developing blade 8b forms a thin layer of toner on the developing roller 8a formed of a semiconductive rubber material. The toner is strongly rubbed between the developing roller 8a and developing blade 8b to become triboelectrically charged. In the present invention, the toner is negatively charged.

The triboelectrically charged toner migrates from the developing roller 8a to the electrostatic latent image by the Coulomb force so that the electrostatic latent image is developed with the toner into a toner image. The sponge roller 8c serves to supply an appropriate amount of toner to the developing blade 8b at all times. When the toner is exhausted, the toner tank 8d can be replaced for new, fresh toner.

The developing sections 8 of the print engines 2-5 hold yellow toner, magenta toner, cyan toner, and black tone, respectively.

A carrier belt 28 is pressure-sandwiched between the photoconductive drum 7 and transfer roller 17 at each print engine, and runs along the transport path of the recording paper 30. The carrier belt 28 is an endless belt formed of a high resistance semiconductive plastic film, and is mounted about a drive roller 25, driven roller 26, and a tension roller 27. The carrier belt 28 has an electrical resistance such that the recording paper 30 is electrostatically sufficiently attracted to the carrier belt 28, and when the recording paper 30 leaves the carrier belt 28, the static electricity on the carrier belt 28 is automatically neutralized.

A motor, not shown, drives the driven roller 25 to rotate about the Y-axis in a direction shown by arrow D, thereby driving the carrier belt 28 to rotate. The tension roller 27 is urged by an urging spring, not shown, to impart a tension to the carrier belt 28 in a direction shown by arrow E. An upper half 28a of the carrier belt 28 is sandwiched between the photoconductive drums 7 and the transfer roller 17 at the respective print engines 2-5.

There is provided a cleaning blade 31 near the driven roller 26. The cleaning blade 31 is in pressure contact with the carrier belt 28. The edge of the cleaning blade 31 scrapes the residual toner clinging to the carrier belt 28 to collect the residual toner into a waste toner tank 32.

As shown in FIG. 1, there is provided a paper-feeding mechanism 40 under the drive roller 25. The paper-feeding mechanism 40 includes a paper cassette 41, a hopping mechanism 42, and a registry roller 43. The paper cassette 41 includes a paper holding box 44, bottom plate 45, and a spring 46. The hopping mechanism 42 includes a paper separator 47, a spring 48, and a feeding roller 49. The hopping mechanism causes the recording paper 30 to advance from the paper box 44 into a paper path defined by guide rollers 50 and 51, so that the recording paper 30 reaches a registry roller 43 that is in pressure contact with a transport roller 52.

### Transportation of Recording Paper

The transport of the recording paper 30 will be described.

A stack of the recording paper 30 held in the paper-holding box 44 is placed on the bottom plate 45 upwardly urged by the spring 46, so that the top page of the stack of the recording paper 30 is in pressure contact with the feeding roller 49. The feeding roller 49 is urged by the spring 48 against the paper separator 47. When the feeding roller 49 is driven by a motor, not shown, to rotate in the D-direction, the feeding roller 49 cooperates with the paper separator 47 to advance only the top page of the stack into the paper path.

When a motor, not shown, drives the transport roller 52 to rotate in the C-direction, the recording paper 30 is pulled in between an attraction roller 53 and the carrier belt 28. The attraction roller 53 is in pressure contact with the drive roller 25, and charges the recording paper 30 so that the recording paper 30 is attracted to the carrier belt 28 electrostatically. For this purpose, the attraction roller 53 is formed of a high-resistance electrically semiconductive rubber material. A photo-interrupter 54 is provided between the attraction roller 53 and the print engine 2 to detect the leading edge of the recording paper 30.

There is provided a neutralizer 55 at the end of the transport path, the neutralizer 55 being on the opposite side of the carrier belt 28 from the driven roller 26. The neutralizer 55 neutralizes the recording paper 30 so that the recording paper 30 can leave the carrier belt 28 easily. A photo-interrupter 56 is disposed downstream of the neutralizer 55 to detect a trailing end of the recording paper 30.

In addition to the photo-interrupter 56, a paper guide 57 and a fixing unit 60 are disposed downstream of the neutralizer 55. The fixing unit 60 includes a heat roller 61 and a pressure roller 62 in pressure contact with the heat roller 61, and fixes the toner image on the recording paper 30 when the recording paper 30 passes between the pressure roller 62 and the heat roller 61. A paper exit 63 is defined downstream of the fixing unit 60 through which the recording paper 30 is discharged onto a paper stacker 64.

### Construction of LED Head

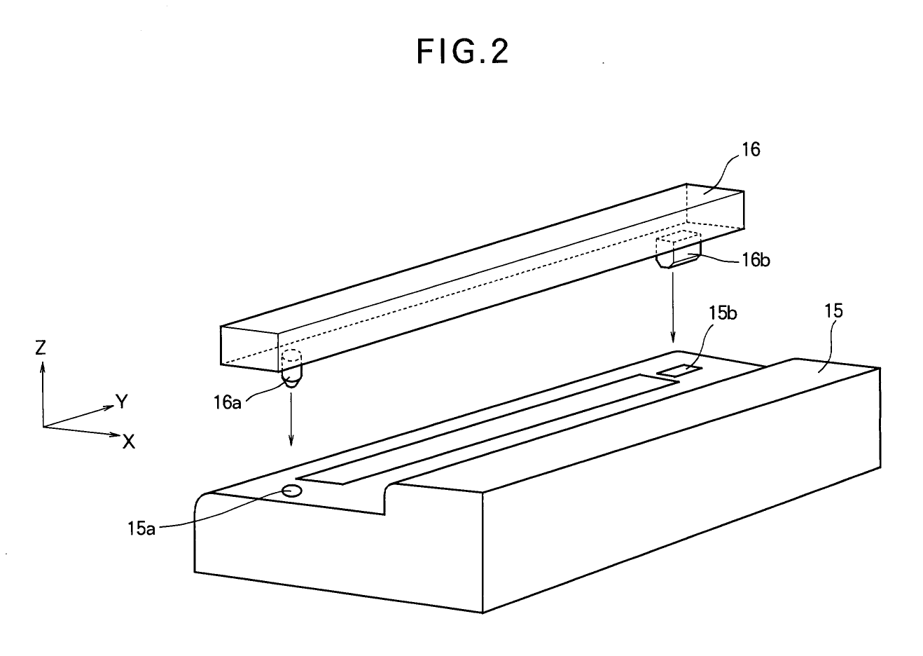

FIG. 2 illustrates a configuration of an LED head mounted on each print engine.

Each of the print engines 2-5 has an LED head 16 assembled to the image forming section 15. The LED head 16 has a cylindrical boss 16a and a rectangular boss 16b. The LED head 16 has a row of a plurality of arrays of light-emitting diodes (LEDs). The arrays are aligned in a direction in which the LEDs are aligned in each array. Drive mechanisms 11e-11h drive various parts of the respective print engines 2-5 in rotation. The image forming section 15 has a round hole 15a and a rectangular hole 15b formed therein. When the LED head 16 is mounted on the image forming section 15, the cylindrical boss 16a fits into the round hole 15a and the rectangular boss 16b fits into the rectangular hole 15b, so that the LED head 16 is placed in position.

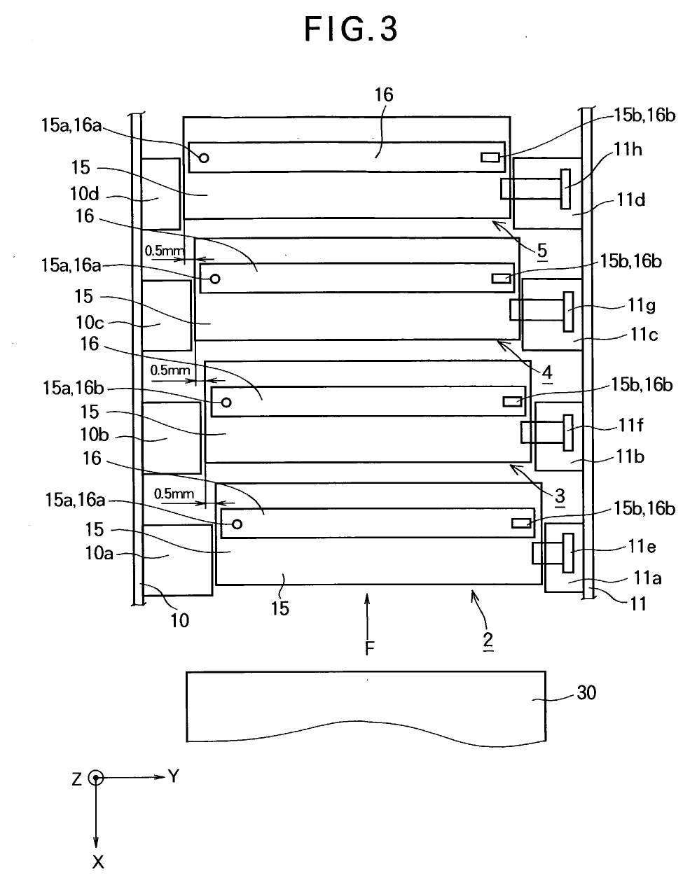

FIG. 3 illustrates the print engines 2-5 arranged in the color image-recording apparatus 1.

Referring to FIG. 3, the respective print engines 2-5 are supported on a pair of opposed side frames 10 and 11 built in the color image-recording apparatus 1. The side frame 10 has positioning brackets 10a-10d fixed thereto while the side frame 11 has positioning brackets 11a-11d. The brackets 10-10d and 11a-11d support the print engines 2-5 thereon and the LED heads 16 extend in directions perpendicular to the transport path of the recording paper 30.

The brackets 10a-10d have dimensions such that each bracket has a width 0.5 mm smaller than a preceding one and the brackets 11a-11d have dimensions such that each bracket has a width 0.5 mm larger than a preceding one. Thus, when the print engines 2-5 have been assembled into the image-forming unit 14, the print engines 2-5 are staggered such that a following one of adjacent print engines is 0.5 mm ahead of a preceding one. That is, adjacent rows of LED arrays for print engines 2-5 are staggered so that adjacent endmost LEDs of adjacent arrays in a preceding one of the adjacent rows are 0.5 mm ahead of corresponding adjacent endmost LEDs of the adjacent arrays in a following one of the adjacent rows.

Therefore, areas between adjacent LED arrays of each LED head 16 are also disposed 0.5 mm ahead of corresponding ones of a preceding LED head, eliminating chances of such areas being aligned straight in the direction (A-direction of FIG. 1) in which the recording paper 30 is transported. Thus, when the respective color images are transferred one over the other in register to the recording paper 30, the image portions corresponding to the areas between adjacent LED arrays of the respective LED heads are dispersed, thereby making such areas not detectable.

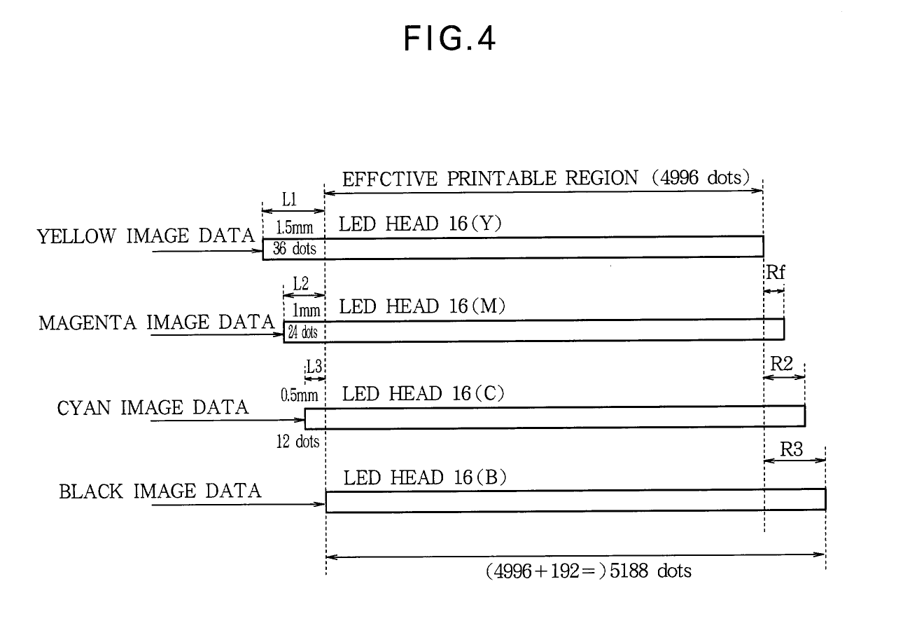

FIG. 4 illustrates positional relationship among the LED heads in the color image-recording apparatus 1.

In the present invention, it is assumed that the resolution of the LED head is 600 dpi (dots per inch). Thus, LEDs in each LED array are aligned at intervals of 42.3 μm (25.4 mm/600 dots=42.3 μm). Each LED arrays has 192 LEDs fabricated therein and a length of about 8 mm. The LED head has 26 LED arrays capable of printing 4996 dots (8×26=208 mm), which is enough to print in a lateral direction when A4 size paper (210×297 mm) is placed in an upright position. A4 size paper is usually printed with a top margin of 5 mm, a bottom margin of 10 mm, and left and right margins of 5 mm. Therefore, 4996 dots are enough for printing A4 size paper. A displacement of the row of LED arrays by 0.5 mm is equivalent to about a displacement by 12 bits (0.5 mm/42.3 μm=11.8 dots). It is to be noted that an effective printable region on A4 size paper is narrower by 0.5×3=1.5 mm when the LED heads 16 are staggered than when the LED heads 16 are not staggered. A displacement of 1.5 mm is equivalent to a shifting of 36 dots. Such a reduction in effective print region can be compensated for by employing more LED arrays and drive ICs in each row. The LED heads 16 are staggered so that adjacent endmost light-emitting elements of adjacent arrays in a preceding one of the adjacent rows are a predetermined distance ahead of corresponding adjacent endmost light-emitting elements of the adjacent arrays in a following one of the adjacent rows. The recording paper 30 travels in the direction shown by arrow A. The drive ICs of the respective rows drive corresponding LED arrays so that LEDs of each row illuminate areas on the surface of a preceding photoconductive drum 7 corresponding to areas of the surface of a following photoconductive drum 7. Thus, the images formed by the LED head of the print engines 2-5 are properly transferred in register to the recording paper 30.

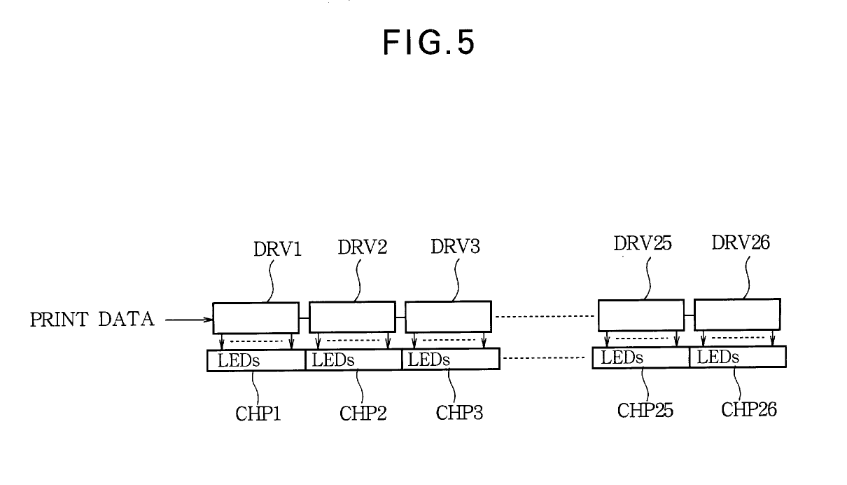

FIG. 5 illustrates the driver ICs and LED arrays chips arranged on the circuit board for one of the LED heads 16.

Referring to FIG. 5, each drive IC drives LEDs of a corresponding LED array chip.

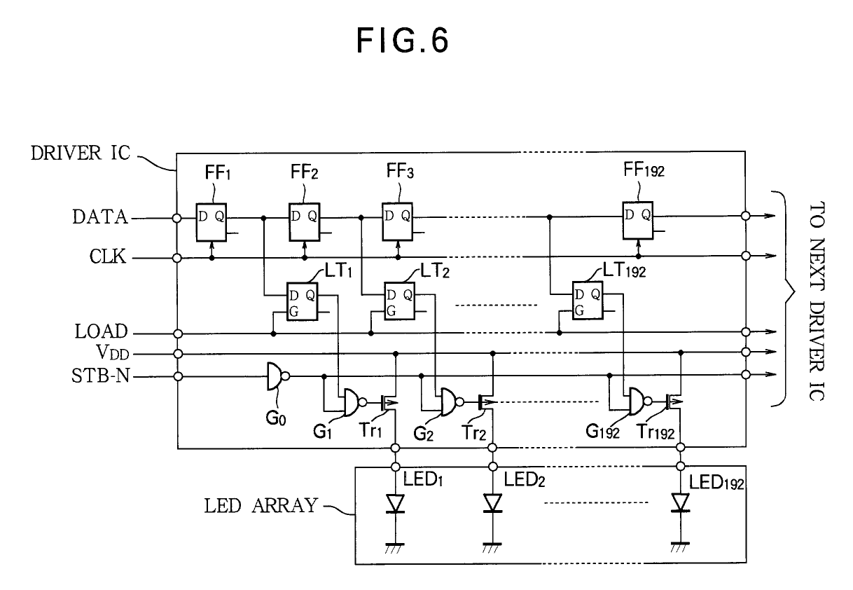

FIG. 6 illustrates the detailed circuit configuration in each drive IC and LED array, showing electrical connection.

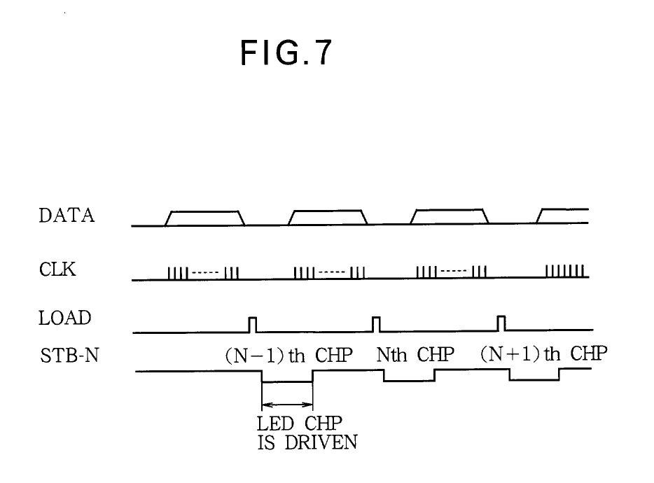

FIG. 7 is a timing chart for driving drive ICs and LED arrays, showing only (N−1)th drive IC and LED array to (N−1)th drive IC and LED array by way of example.

Referring to FIGS. 4, 6, and 7, bits of print data are inputted into DATA of the first drive IC DRV1, the bits being shifted through flip-flops FF1 to FF192 on a bit-by-bit basis upon a clock signal applied to CLK.

For the respective color image data, 4996-bit data is inputted to DATA of DRV1 and shifted 4996 times upon clock signals through the corresponding LED heads 16. For yellow image data, the 4996-bit data is followed by 36 bits, which indicate non-energized LEDs. For magenta image data, 4996-bit data is preceded by 12 bits indicative of non-energized LEDs and followed by 24 bits, the 12 bits and 24 bits indicating non-energized LEDs. For cyan image data, 4996-bit data is preceded by 24 bits and followed by 12 bits, the 24 bits and 12 bits indicating non-energized LEDs. For black image data, 4996-bit data is preceded by 36 bits, which indicate non-energized LEDs.

After all the bits have been shifted through the flip-flops FF1 to FF192, a load signal is inputted to LOAD to latch the bit data on the FF1 to FF192 into latches LT1 to LT192. Then, a strobe signal is inputted to STB-N for Nth LED array, thereby energizing LED1 to LED192. Likewise, the bits of image data are shifted through the driver ICs in sequence. The LED arrays are driven to emit or not to emit light for a certain length of time to form a dot of an electrostatic latent image on the photoconductive drum 7.

It is to be noted that LEDs, driving elements Tr and latches LT corresponding to non-energized LEDs are not required to be mounted on the circuit board. They may simply be omitted.

### Overall Control of Apparatus

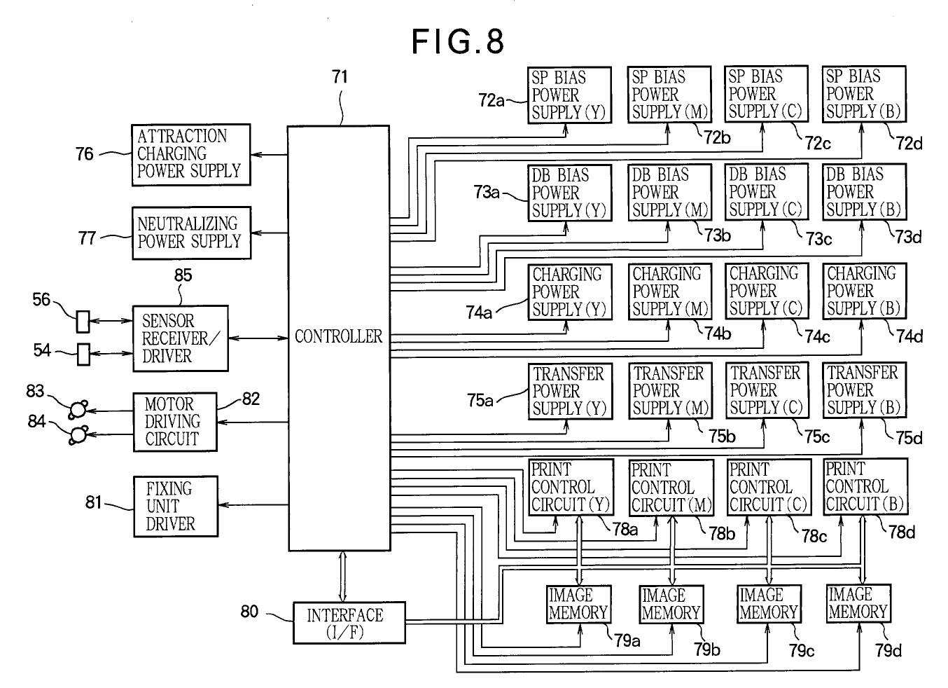

FIG. 8 is a block diagram of a control circuit that controls the respective mechanisms of the color image-recording apparatus 1 of FIG. 1. References (Y), (M), (C), and (K) denote yellow print engine, magenta print engine, cyan print engine, and black print engine, respectively.

A controller 71 takes the form of, for example, a microprocessor and controls the overall operation of the color image-recording apparatus 1. The controller 71 sends commands or control signals to the following sections: SP bias power supplies 72a-72d, DB bias power supplies 73a-73d, charging power supplies 74a-74d, and transferring power supplies 75a-75d. The SP bias power supplies 72a-72d supply voltages to the sponge rollers of the print engines 2-5. The DB bias power supplies 73a-73d supply voltages to the developing rollers 8a of the print engines 2-5. The charging power supplies 74a-74d supply voltages to the charging rollers 18 of the print engines 2-5. The transferring power supplies 75a-75d supply voltages to the transfer rollers 17 of the print engines 2-5.

Likewise, the controller 71 sends commands or control signals to attraction charging power supplies 76 that supply voltages to the attraction roller 53, and to a neutralizing power supply 77 that supplies a voltage to the neutralizer 55. The drive roller 25 is grounded and a difference in potential between the attraction roller 53 and the drive roller 25 causes the recording paper 30 to be electrostatically attracted to the carrier belt 28. The controller 71 controls the aforementioned power supplies to be turned on and off.

The controller 71 sends commands and control signals to printing controlling circuits 78a-78d. Upon receiving the commands and controls signals, the printing controlling circuits 78a-78d read image data from corresponding memories 79a-79d. Then, the printing controlling circuits 78a-78d transmit the print data to the LED heads 16 of the corresponding print engines 2-5, thereby driving the LEDs 22 of the LED heads 16 to emit light in accordance with the image data of corresponding colors. The light illuminates the charged circumferential surface of the photoconductive drum 7 to form an electrostatic latent image on the photoconductive drum 7. The memories 79a-79d store image data received from an external host apparatus, e.g., host computer, through the interface 80.

The interface 80 separates the received image data into the respective color image data, and stores yellow image data into the memory (Y) 79a, magenta image data into the memory (M) 79b, cyan image data into the memory (C) 79c, and black image data into the memory (K) 79d, respectively.

In accordance with the commands and controls signals from the controller 71, a fixing unit driver 81 drives a heater, not shown, in the heat roller 61 to maintain the temperature of the heat roller 61 at a constant temperature. Likewise, in accordance with the commands and control signals from the controller 71, a motor driver 82 controls a motor 83 and a motor 84. The motor 83 drives the feeding roller 49, transport roller 52, and registry roller 43 in rotation. The motor 84 drives the photoconductive drum 7, charging roller 18, developing roller 8a, sponge roller 8c, transfer roller 17, driving roller 25, and heat roller 61 in rotation. The rotating members driven by the motor 84 are operatively coupled to one another by means of gears or belts, not shown.

A sensor receiver/driver 85 drives the photo interrupters 54 and 56 that detect the leading edge and trailing edge of the recording paper 30, respectively, and sends the detection signals to the controller 71.

### Printing Operation of Color Image-Firming Apparatus

The printing operation of the color image-recording apparatus of the aforementioned configuration will be described.

When the color image recording apparatus 1 is powered on, the controller 71 performs initialization and then performs a warm up operation in which the controller 71 controls the fixing unit driver 81 to heat the heat roller 61 to a predetermined temperature. Then, the fixing unit driver 81 performs a control operation to maintain the heat roller at the predetermined temperature. After the warm up operation, the controller 71 causes the motor driver 82 to drive the motor 84, thereby driving the drive roller 25 and other members so that the upper half 28a of the carrier belt 28 runs in a direction shown by arrow F.

Shortly after the power up, the carrier belt 28 runs slightly more than one complete rotation thereof before it comes to a stop, so that the cleaning blade 31 scrapes completely dust and residual toner from the carrier belt 28 into a waste toner tank 32. The initialization of the color image-recording apparatus 1 is completed and the apparatus 1 enters a standby state where the apparatus 1 waits for image data supplied from the external host apparatus through the interface 80.

When the apparatus 1 at the standby state receives image data from the external host apparatus through the interface 80, the controller 71 provides a command to the interface 80 and memories 79a-79d. In response to the command, the interface 80 separates the received image data into color image data of the respective colors and stores the respective color image data into the corresponding memories 79a-79d. In this manner, the respective memories 79a-79d store corresponding color image data for one page of the recording paper 30.

A printing operation will be described in which the color image data is printed on the recording paper 30.

The controller 71 causes the motor driver 82 to drive the motor 84, thereby rotating the photoconductive drums 7, charging rollers 18, developing rollers 8a, sponge rollers 8c, transfer rollers 17, drive roller 25, and heat roller 61.

The controller 71 causes the motor driver 82 to drive the motor 83, thereby rotating the feeding roller 49. The feeding roller 49 rotates to feed the top page of the stack of recording paper 30 held in the paper holding box 44 into the paper path defined by the guides 50 and 51. The controller 71 controls the motor driver 82 so that the recording paper 30 is transported a little further after the leading edge of the recording paper 30 reaches the registry roller 43. Therefore, the recording paper 30 has a slack therein with the leading edge abutting the transport roller 52 and the registry roller 43, thereby removing a skewed condition of the recording paper 30.

The controller 71 causes the motor driver 82 to drive the motor 83, thereby controlling the motor to rotate in a reverse direction so that the transport roller 52 and registry roller 43 rotate in rearward directions. At the same time, the controller 71 turns on the attraction charging power supply 76 to supply a voltage to the attraction roller 53. The transport roller 52 rotates in the C-direction so that the transport roller 52 and registry roller 43 cooperate to advance the leading edge of the recording paper 30 toward a point where the carrier belt 28 contacts the attraction roller 53.

At this moment, the carrier belt 28 attracts the leading end portion of the recording paper 30 by the Coulomb force between the attraction roller 53 and drive roller 25. The transport roller 52 rotates in the same direction so that the recording paper 30 is transported in the F direction while it is being attracted to the carrier belt 28. The leading edge of the recording paper 30 then reaches the photo interrupter 54 that sends a detection signal through the sensor receiver/driver 85 to the controller 71. When the trailing edge of the recording paper 30 leaves the separator 47, the controller 71 causes the motor driver 82 to stop the motor 53.

When the photo interrupter 54 detects the leading edge of the recording paper 30, the controller 71 turns on the charging power supplies 74a-74d, the DB bias power supplies 73a-73d, and the SP bias power supplies 72a-72d. Thus, the charging rollers 18 uniformly charge the photoconductive drums 7 of the print engines 2-5 and the sponge rollers 8c and developing roller 8a receive high voltages.

The controller 71 sends a command to the memory (Y) 79a, which holds yellow image data, to send the yellow image data to the print control circuit (Y) 78a. In response to the command from the controller 71, the print control circuit (Y) 78a converts the yellow image data into such a signal that the LED head 16 can operate to illuminate the photoconductive drum 7 to form an electrostatic latent image for yellow image data.

The LED head (Y) 16 energizes LEDs corresponding to dots of the image data received to form an electrostatic latent image for one line. In this manner, the yellow image data outputted from the memory (Y) 79a is converted into an electrostatic latent image on a line-by-line basis until an electrostatic latent image for one complete page is formed. The charged yellow toner is deposited on the electrostatic latent image by the Coulomb force to form a yellow toner image. In this manner, the yellow electrostatic latent image is developed into a yellow toner image.

When the leading edge of the recording paper 30 reaches a transfer point where the photoconductive drum 7 is in contact with the transfer roller (Y) 17, the controller 71 turns on the transfer power supply (Y) 75a of the print engine 2. Thus, the toner image on the photoconductive drum 7 is transferred onto the recording paper 30 as the photoconductive drum 7 rotates in sequence, so that the toner image for one complete page-is transferred onto the recording paper 30.

When the trailing edge of the recording paper 30 reaches the transfer point, the controller 71 turns off the transfer power supply (Y) 75a, charging power supply (Y) 74a, DB bias power supply (Y) 73a, and SP bias power supply (Y) 72a.

The carrier belt 28 continues to run so that the recording paper 30 reaches the print engine 3.

### Transfer Operation of Respective Images in Register

The transfer operation of a magenta image will be described.

The controller 71 sends a command to the memory (M) 79b, which holds magenta image data, to send the magenta image data for one line to the print control circuit (M) 78b of the print engine 3. In response to the command from the controller 71, the print control circuit 78b converts the image data into such a signal that the LED head 16 can operate to illuminate the photoconductive drum 7 to form an electrostatic latent image for the magenta image data.

The LED head 16 energizes the LEDs corresponding to the received magenta image data to form an electrostatic latent image for one line on the charged surface of the photoconductive drum 7. In this manner, the magenta image data outputted from the memory (M) 79b is converted into an electrostatic latent image on a line-by-line basis until an electrostatic latent image for one complete page is formed. The charged magenta toner is deposited on the electrostatic latent image by the Coulomb force to form a magenta toner image.

The magenta toner image is then transferred in registration with the yellow toner image to the recording paper 30.

The carrier belt 28 continues to run so that the recording paper 30 reaches the print engine 4 where a cyan toner image is transferred in registration with the yellow toner image and the magenta toner image onto the recording paper 30. After the transfer of the cyan toner image, the recording paper 30 advances to the print engine 5 where a black toner image is transferred in registration with the yellow, magenta, and cyan toner images onto the recording paper 30.

As mentioned above, the respective color images are transferred in registration on the recording paper 30. Then, when the recording paper 30 advances close to the neutralizer 55, the controller 71 turns on the neutralizing power supply 77 to neutralize the recording paper 30. Thus, the recording paper 30 can smoothly leave the carrier belt 28 above the driven roller 26 and is then guided by the paper guide 57 into the fixing unit 60. As soon as the recording paper 30 leaves the neutralizer 77, the controller 71 turns off the neutralizing power supply 77.

The fixing unit 60 is in a standby state where the heat roller 61 has been heated to a temperature required for fusing the toner image on the recording paper 30. When the recording paper 30 passes between the heat roller 61 and the pressure roller 62, the toner image on the recording paper 30 is fixed permanently. The recording paper 30 is then discharged through the paper exit 63 to the paper stacker 64. The photo interrupter 56 detects the trailing edge of the recording paper 30 and indicates to the controller 71 that the recording paper 30 has been discharged to the paper stacker 64.

As soon as the toner images have been transferred to the recording paper 30 at the respective print engines 2-5, the controller 71 turns off the charging power supplies 74a-74d, SP bias power supplies 72a-72d, DB bias power supplies 73a-73d, and transfer power supplies 75a-75d. After discharging the recording paper 30 to the paper stacker 64, the controller 71 causes the motor driver 82 to stop the motors 83 and 84.

### SECOND EMBODIMENT

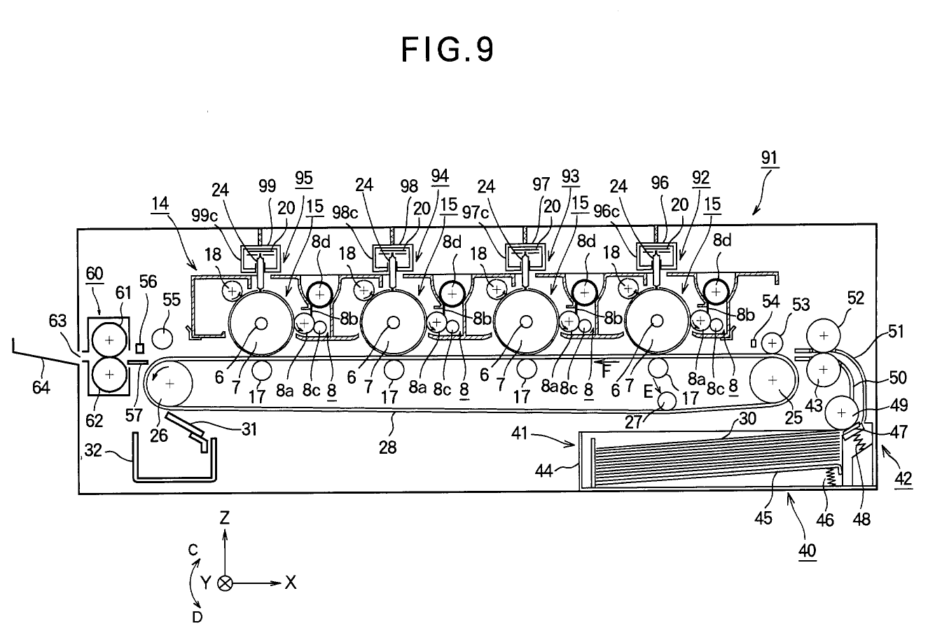

FIG. 9 is a front view of a color image-recording apparatus according to a second embodiment.

The second embodiment differs from the first embodiment in the positions of the circuit board 20 and self-focusing lens 24 that are mounted on the LED heads 96-99.

The second embodiment will be described primarily with respect to portions different from the first embodiment.

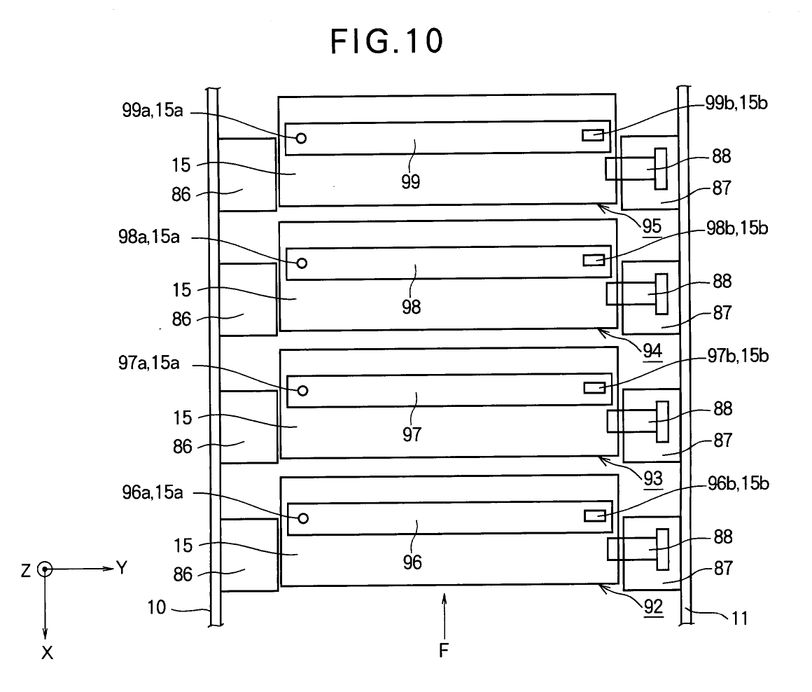

FIG. 10 is a top view of an image-forming unit, illustrating the positional relation of the respective print engines fixed to frames of the image-forming unit.

Referring to FIG. 10, the print engines 92-95 are supported on a pair of opposed side frames 10 and 11 in the color image-recording apparatus 1. The side frame 10 has positioning brackets 86 fixed thereto while the side frame 11 has positioning brackets 87 fixed thereto. The print engines 92-95 are supported on the brackets 86 and 87 in position.

As opposed to the first embodiment, the brackets 86 and 87 support the print engines 92-95 so that the print engines 92-95 are not staggered but aligned evenly. The drive mechanisms 88 drive the rotating members in rotation.

FIG. 11 illustrates the positional relationship among the circuit board 20 and the self-focusing lens 24 of the LED heads 92-95.

Referring to FIG. 11, the LED heads 16 have cylindrical bosses 96a-99a and rectangular bosses 96b-99b. Each image forming section 15 has a round hole 16a and a rectangular hole 16b formed therein. The LED heads 16 are mounted on the corresponding image forming sections 15 in the same manner as in the first embodiment.

The circuit boards 20 and self-focusing lens arrays 24 of the respective LED heads 96-99 are staggered such that each row of LED arrays is disposed 0.5 mm ahead of a preceding one.

As described above, the configuration of the second embodiment provides the same advantages as the first embodiment. Unlike the first embodiment, the brackets 86 and 87 can be of the same structure, saving manufacturing costs.

While each row of the LED arrays is disposed 0.5 mm ahead of a preceding one, the row can be disposed a different distance ahead of the preceding one. Moreover, the rows can be staggered irregularly, provided that areas between adjacent LED arrays of the LED head 16 are sufficiently staggered so that the areas not detectable in the printed image.

While the embodiments have been described with respect to a light source in the form of LEDs, the same advantages can be obtained by using other self light-emitting elements such as electroluminescence elements and laser diodes, or a plurality of array elements such as LCD having a separate light source.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. An image recording apparatus, comprising:
a plurality of image-forming sections that record corresponding toner images on a recording medium in register;
a plurality of exposing units each of which is mounted to a corresponding one of said plurality of image-forming sections; and
a plurality of rows of arrays of light-emitting elements, each of said plurality of rows being mounted to a corresponding one of said plurality of exposing units, each of said plurality of rows having a plurality of light-emitting elements and being aligned straight in a direction in which the plurality of light-emitting elements are aligned;
wherein adjacent rows are staggered so that adjacent endmost light-emitting elements of adjacent arrays in a preceding one of the adjacent rows are a predetermined distance ahead of corresponding adjacent endmost light-emitting elements of the adjacent arrays in a following one of the adjacent rows.

2. The apparatus according to claim 1, wherein said plurality of image-forming sections are of a same configuration;
wherein said plurality of image-forming sections are staggered so that adjacent endmost light-emitting elements of adjacent arrays in a preceding one of the adjacent rows are a predetermined distance ahead of corresponding adjacent endmost light-emitting elements of the adjacent arrays in a following one of the adjacent rows.

3. The apparatus according to claim 1, wherein said plurality of image-forming sections are of a same configuration,
wherein said plurality of exposing units are mounted to the plurality of image-forming sections in a staggered fashion so that adjacent endmost light-emitting elements of adjacent arrays in a preceding one of the adjacent rows are a predetermined distance ahead of corresponding adjacent endmost light-emitting elements of the adjacent arrays in a following one of the adjacent rows.
